(19) United States
(12) Patent Application Publication
(10) Pub. No.: US 2015/0103406 A1
(43) Pub. Date: Apr. 16, 2015

(54) OPTICAL MEMBER, IMAGE PICKUP APPARATUS, AND METHOD FOR MANUFACTURING OPTICAL MEMBER

(71) Applicant: CANON KABUSHIKI KAISHA, Tokyo (JP)

(72) Inventors: Kenji Takashima, Tokyo (JP); Zuyi Zhang, Yokohama-shi (JP); Yoshinori Kotani, Yokohama-shi (JP); Akiko Takei, Fujisawa-shi (JP); Akira Sugiyama, Yokohama-shi (JP); Naoyuki Koketsu, Tokyo (JP)

(21) Appl. No.: 14/403,981

(22) PCT Filed: May 17, 2013
(86) PCT No.: PCT/JP2013/003160

§ 371 Date: Nov. 25, 2014

(30) Foreign Application Priority Data
May 30, 2012 (JP) 2012-123566
May 2, 2013 (JP) 2013-097078

(51) Int. Cl. G02B 1/118; C03C 15/00; C03C 23/00; C03C 17/04

(52) U.S. Cl. CPC G02B 1/118; C03C 17/04; C03C 15/00; C03C 23/008; C03C 2217/425; C03C 2218/17; C03C 2218/33
USPC 359/601; 65/31; 65/17.2

(57) ABSTRACT

This invention provides an optical member in which ripple is suppressed and a porous glass layer is formed on a base member and also provides a method for easily manufacturing the optical member.

An optical member has a base member (1) and a porous glass layer (2) formed on the base member (1), in which a textured structure is formed on the interface contacting the porous glass layer (2) of the base member (1) and the height of the textured structure is 100 nm or more and equal to or lower than the thickness of the porous glass layer (2).

### TECHNICAL FIELD

The present invention relates to an optical member having a porous glass layer on a base member, an image pickup apparatus having the optical member, or a method for manufacturing the optical member.

### BACKGROUND ART

In recent years, porous glass has been expected to be industrially utilized as an adsorbent, a microcarrier support, a separation film, an optical material, and the like, for example. In particular, the porous glass has been widely utilized as an optical member due to a characteristic such that the refractive index is low.

As a method for relatively easily manufacturing the porous glass, a method utilizing a phase separation phenomenon is mentioned. As the base member of the porous glass obtained utilizing the phase separation phenomenon, borosilicate glass containing silicon oxide, boron oxide, alkali metal oxide, or the like as the raw materials is generally used. The porous glass is manufactured by heat treating the borosilicate glass at a fixed temperature to separate the phases into a silicon-oxide-rich phase and a non-silicon-oxide-rich phase (hereinafter referred to as phase separation treatment), and then eluting the non-silicon-oxide-rich phase with an acid solution (hereinafter referred to as etching treatment). The skeleton constituting the porous glass thus manufactured mainly contains silicon oxide. The skeleton diameter, the pore diameter, and the porosity of the porous glass affect the reflectance and the refractive index of light.

NPL 1 discloses a configuration in which the porosity is controlled by partially making the elution of a non-silicon-oxide-rich phase insufficient in etching, so that the refractive index becomes larger from the surface to the inside, in which the reflection on the surface of porous glass is reduced.

On the other hand, PTL 1 discloses a method for forming a porous glass layer on a base member. Specifically, a film containing borosilicate glass (phase separable glass) is formed by a printing method on the base member, and then the porous glass layer is formed on the base member by phase separation treatment and etching treatment.

### CITATION LIST

### Patent Literature

PTL 1: Japanese Patent Laid-Open No. 01-083583

### Non Patent Literature

NPL 1: J. Opt. Soc. Am., Vol. 66, No. 6, 1976

### SUMMARY OF INVENTION

### Technical Problem

When the porous glass layer of several micrometers is formed on the base member as in PTL 1, reflected light on the surface of the porous glass and reflected light on the interface of the base member and the porous glass of light entering the porous glass surface interfere with each other, and thus ripple (interference fringe pattern) arises.

NPL 1 does not disclose the configuration in which the porous glass layer is formed on the base member. Furthermore, according to the method of NPL 1, since the degree of progress of etching is difficult to control, the refractive index is also difficult to control. Moreover, since a non-silicon-oxide-rich phase which is a soluble component remains, the water resistance decreases, which poses a problem of fogging and the like in the use as an optical member.

The present invention provides an optical member in which ripple is suppressed and a porous glass layer is formed on a base member and also provides a method for easily manufacturing the optical member.

### Solution to Problem

The optical member of the invention is an optical member having a base member and a porous glass layer formed on the base member, in which a textured structure is formed on the interface contacting the porous glass layer of the base member and the height of the textured structure is 100 nm or more and equal to or lower than the thickness of the porous glass layer.

A method for manufacturing an optical member of the invention is a method for manufacturing an optical member having a base member and a porous glass layer formed on the base member, and the method includes preparing a base member having a textured structure and forming a porous glass layer on the surface of the textured structure of the base member, in which the height of the textured structure is 100 nm or more and equal to or lower than the thickness of the porous glass layer.

### Advantageous Effects of Invention

The invention can provide an optical member in which ripple is suppressed and a porous glass layer is formed on a base member and a method for easily manufacturing the optical member.

### BRIEF DESCRIPTION OF DRAWINGS

FIG. 1 is a cross-sectional schematic view illustrating an example of an optical member of the invention.

FIG. 2 is a view for describing ripple.

FIG. 3 is a view for describing the porosity.

FIG. 4A is a view for describing the average pore diameter and the average skeleton diameter.

FIG. 4B is a view for describing the average pore diameter and the average skeleton diameter.

FIG. 5 is a schematic view illustrating an image pickup apparatus of the invention.

FIG. 6A is a cross-sectional schematic view for describing an example of a method for manufacturing an optical member of the invention.

FIG. 6B is a cross-sectional schematic view for describing an example of the method for manufacturing an optical member of the invention.

FIG. 6C is a cross-sectional schematic view for describing an example of the method for manufacturing an optical member of the invention.

FIG. 6D is a cross-sectional schematic view for describing an example of the method for manufacturing an optical member of the invention.

FIG. 6E is a cross-sectional schematic view for describing an example of the method for manufacturing an optical member of the invention.

FIG. 7A is a plan schematic view illustrating an example of a textured structure provided on the optical member of the invention.

FIG. 7B is a plan schematic view illustrating an example of the textured structure provided on the optical member of the invention.

FIG. 7C is a plan schematic view illustrating an example of the textured structure provided on the optical member of the invention.

FIG. 7D is a plan schematic view illustrating an example of the textured structure provided on the optical member of the invention.

FIG. 8 is a SEM image of the cross section of an optical member produced in Example 1.

FIG. 9 is a SEM image of the cross section of an optical member produced in Comparative Example 1.

FIG. 10 is a view showing the dependency of the reflectance on the wavelength of Examples 1 to 9.

FIG. 11 is a view showing the dependency of the reflectance on the wavelength of Comparative Examples 1 to 3.

FIG. 12 is a view showing the relationship of a textured structure and Examples and Comparative Examples.

FIG. 13 is a view illustrating an example of a porous structure derived from spinodal type phase separation.

FIG. 14 is a view illustrating an example of a porous structure derived from binodal type phase separation.

FIG. 15 is a cross-sectional schematic view for describing an example of a process for forming a textured structure on a base member.

FIG. 16 is a SEM image of the cross section of an optical member produced in Example 10.

FIG. 17 is a view showing the dependency of the reflectance on the wavelength of Examples 10 to 16.

### DESCRIPTION OF EMBODIMENT

Hereinafter, the invention is described in detail with reference to an embodiment of the invention. To portions which are not particularly illustrated or disclosed in this specification, well-known or known techniques of the concerned technical field are applied.

The “phase separation” in the invention is described taking a case where a borosilicate glass containing silicon oxide, boron oxide, and oxide containing alkali metal for a glass body as an example. The “phase separation” means separating the phases in glass into a phase containing the oxide containing alkali metal and the boron oxide in a higher proportion than the proportion thereof before phase separation (non-silicon-oxide-rich phase) and a phase containing the oxide containing alkali metal and the boron oxide phase in a lower proportion than the proportion thereof before phase separation (silicon-oxide-rich phase). Then, the phase-separated glass is etched to remove the non-silicon-oxide-rich phase, thereby forming a porous structure in the glass body.

The phase separation includes spinodal type phase separation and binodal type phase separation. As a porous glass structure utilizing the phase separation, there are a porous structure derived from the spinodal type phase separation and a porous structure derived from the binodal type phase separation. The porous structure derived from the spinodal type phase separation and the porous structure derived from the binodal type phase separation are judged and distinguished from the shape observation results obtained by a scanning electron microscope (SEM). Specifically, the cross section of the porous glass layer is observed at a magnification of 150,000 times at an accelerating voltage of 5.0 kV using a scanning electron microscope (FE-SEM S-4800, manufactured by Hitachi).

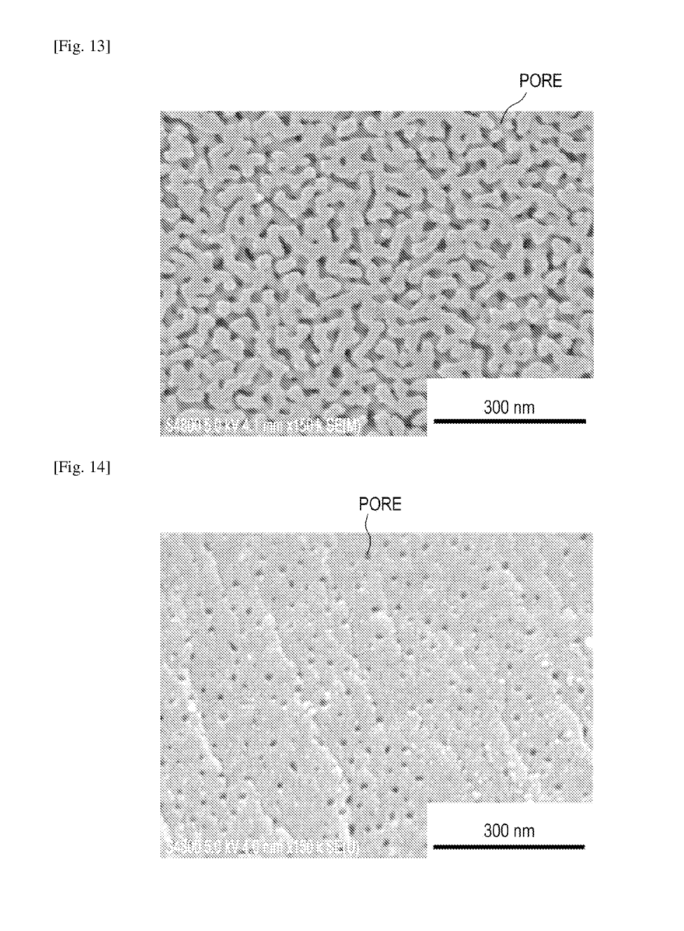

The pores of the porous glass obtained by the spinodal type phase separation are through pores communicating from the surface to the inside. More specifically, the porous structure derived from the spinodal type phase separation is a structure having a shape of an “ant nest”, in which pores three dimensionally communicate with each other and the skeleton formed by silicon oxide corresponds to a “nest” and the through pore corresponds to a “nesting hole”. More specifically, when the pores of the porous structure observed in a field of a magnification of 150,000 times at an accelerating voltage of 5.0 kV using a scanning electron microscope are through pores as illustrated in FIG. 13, the porous structure is the porous structure derived from the spinodal type phase separation.

On the other hand, the porous glass obtained by the binodal type phase separation is a structure in which independent pores which are pores surrounded by a closed surface close to a spherical shape discontinuously exist in the skeleton formed by silicon oxide. More specifically, when the pores of the porous structure observed in a field of a magnification of 150,000 times at an accelerating voltage of 5.0 kV using a scanning electron microscope are independent pores as illustrated in FIG. 14, the porous structure is the porous structure derived from the binodal type phase separation.

The cross-sectional shape of the pores of the porous structure derived from the binodal type phase separation is an approximately circular shape. On the other hand, the cross-sectional shape of the pores of the porous structure derived from the spinodal type phase separation is different from the circular shape and has a branch shape. Therefore, in the porous structure derived from the spinodal type phase separation, the cross-sectional shape of the skeleton also has a branch shape. These cross-sectional shapes are shapes obtained when observed in a field of a magnification of 150,000 times at an accelerating voltage of 5.0 kV using a scanning electron microscope. The porous structure according to each phase separation type can be controlled by controlling the composition of the glass body and the temperature during phase separation.

The invention utilizes the spinodal type phase separation. The porous structure derived from the spinodal type phase separation has a continuous through pore having a three-dimensional net-like continuous through pore communicating from the surface to the inside, in which the porosity can be arbitrarily controlled by changing the heat treatment conditions. The porous structure has a skeleton which is continuous while three dimensionally complicatedly bending. Thus, even when the porosity is increased, high strength can be achieved. Thus, since excellent surface strength can be achieved while maintaining high porosity, the invention can provide an optical member which has excellent antireflection performance and also has strength with which the surface is difficult to be damaged even when touching the surface.

### Optical Element

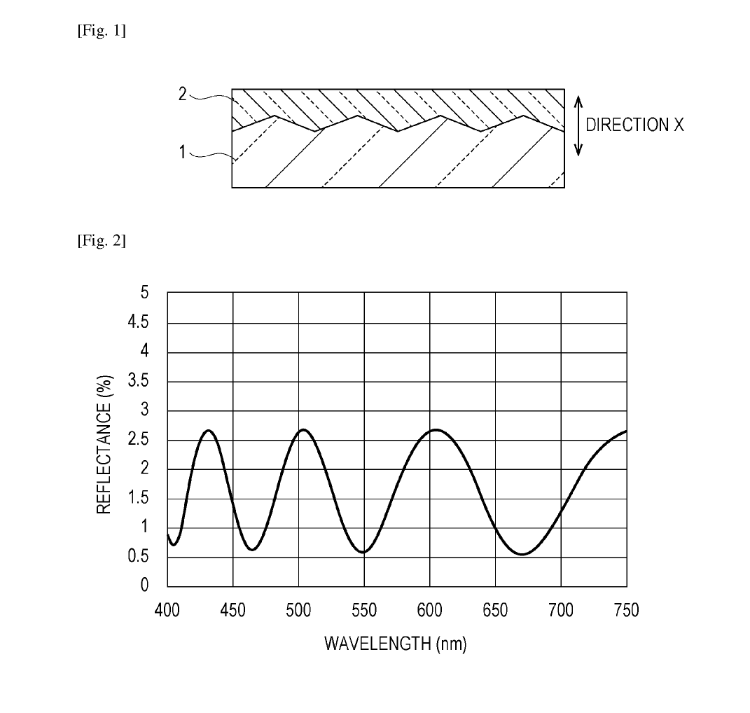

The optical member of the invention has a configuration of having a porous glass layer 2 having a porous structure derived from the spinodal type phase separation in which pores three dimensionally communicate with each other on a base member 1 as illustrated in FIG. 1. Since the porous glass layer 2 is a film whose refractive index is lower than that of the base member 1, the reflection on the interface (surface of the porous glass layer 2) of the porous glass layer 2 and air is suppressed. Thus, the porous glass layer is expected to be utilized as an optical member.

However, in the optical member having the porous glass layer on the base member, a phenomenon referred to as ripple occurs in which an interference fringe pattern appears in reflected light due to an interference effect of reflected light on the surface of the porous glass layer and reflected light on the interference of the base member and the porous glass layer. In particular, when the thickness of the porous glass layer is equal to or more than the wavelength of light and tens of micrometers or lower, the interference effect becomes strong, so that the interference fringe pattern remarkably appears.

The ripple is represented in the form where the high intensity and the low intensity are almost periodically repeated as in the sine wave when the reflectance is measured, and the wavelength is plotted on the horizontal axis and the reflectance is plotted on the vertical axis for graphing and is shown in FIG. 2. FIG. 2 shows the reflectance of a structure in which a porous glass layer is formed with a thickness of 1 micrometer on a quarts glass base member. When such ripple occurs, the dependency of the reflectance on the wavelength becomes strong, so that the porous glass layer is not suitable as an optical member in some cases.

Then, the optical member of the invention employs a configuration such that the porosity substantially increases from the base member 1 to the porous glass layer 2 in the thickness direction (the direction X of FIG. 1) of the porous glass layer 2 near the interface of the base member 1 and the porous glass layer 2. More specifically, the optical member of the invention employs a configuration of having a textured structure on the interface at the side of the porous glass layer 2 of the base member 1. In the configuration, since the porous glass layer 2 is formed also on concave portions of the textured structure, the number of pores and the volume increase from the base member 1 to the porous glass layer 2 in the direction X, so that the substantial porosity increases. With the configuration, a sharp change in the refractive index at the interface of the base member 1 and the porous glass layer 2 is suppressed, and the reflection on the interface is suppressed. As a result, the ripple due to the interference with the reflected light on the surface of the porous glass layer 2 and the reflected light on the interface of the base member 1 and the porous glass layer 2 can be suppressed.

The textured structure of the invention refers to a structure in which the height of the textured structure is 100 nm or more in order to achieve an effect of suppressing the ripple. The textured structure of the invention is a structure in which the width of the convex portion becomes smaller from the side of the base member 1 with increasing the distance from the base member 1. The height of the textured structure is the distance in the thickness direction of the porous glass layer 2 between the peaks of the convex portion and the concave portion which are adjacent to each other. When the height of the textured structure is smaller than 100 nm, an effect of reducing a change in the refractive index near the interface of the base member 1 and the porous glass layer 2 becomes small and a reflection suppressing effect on the interface of the porous glass layer 2 and the base member 1 decreases. The height of the textured structure is more suitably 250 nm or more. On the other hand, the upper limit of the height of the textured structure is equal to or lower than the thickness of the porous glass layer 2 to be formed thereon. When the height of the textured structure is larger than the thickness of the porous glass layer 2, the base member 1 is exposed to the surface. Therefore, the reflection suppressing effect on the surface of the porous glass layer 2 obtained by providing the porous glass layer 2 decreases.

The thickness of the porous glass layer 2 is measured as follows. First, a SEM image (electron micrograph) is captured at an accelerating voltage of 5.0 kV using a scanning electron microscope (FE-SEM S-4800, manufactured by Hitachi). Then, the distance from the surface of the porous glass layer 2 to the peak of the concave portion of the textured structure on the base member 1 is measured at two or more points, and the average value thereof is used.

The thickness of the porous glass layer 2 is not particularly limited and is suitably 1 micrometer or more and 20 micrometer or lower and more suitably 1 micrometer or more and 10 micrometer or lower. When the thickness is smaller than 1 micrometer, the effect of high porosity (low refractive index) is not obtained. When the thickness is larger than 20 micrometer, the influence of scattering becomes high, so that the porous glass layer becomes difficult to be used as an optical member.

The width of the textured structure is the minimum value obtained by measuring the distance between the peaks of the two adjacent convex portions at at least two or more points. The width of the textured structure is not particularly limited insofar as the ripple suppressing effect is demonstrated and is suitably 100 nm or more and 2000 nm or lower. When the width of the textured structure becomes smaller than 100 nm, glass powder becomes difficult to enter the concave portion in a manufacturing method described later, so that cavities are likely to be formed and the scattering level becomes high. When the width of the textured structure exceeds 2000 nm (2 micrometer), the influence of scattering of light becomes remarkable, so that the transmittance decreases.

The porosity of the porous glass layer 2 is suitably 20% or more and 70% or lower and more suitably 20% or more and 60% or lower. When the porosity is lower than 20%, advantages of the porous structure cannot be sufficiently utilized. When the porosity is higher than 70%, the surface strength tends to decrease, and thus the porosity is not suitable. The fact that the porosity of the porous glass layer 2 is 20% or more and 70% or lower is equivalent to the fact that the refractive index is 1.10 or more and 1.40 or lower.

The following measurement method can be used for the measurement of the porosity.

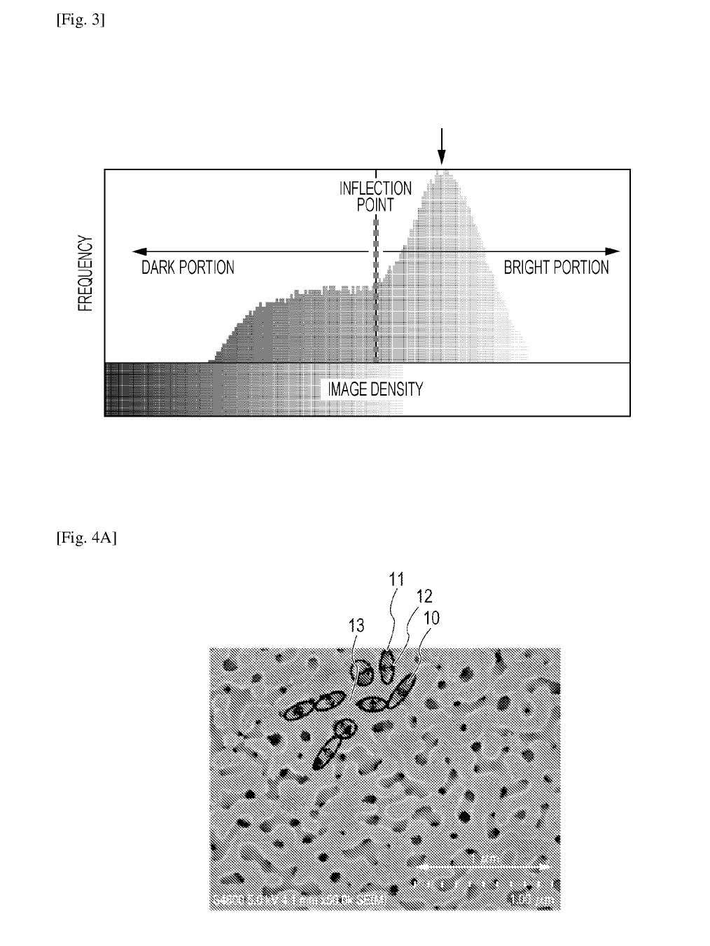

Treatment for binarizing an electron micrograph at a skeleton portion and a pore portion is performed. Specifically, the surface of the porous glass is observed at a magnification of 100,000 times (depending on the case, 50,000 times) at which the contrast of the skeleton is easily observed at an accelerating voltage of 5.0 kV using a scanning electron microscope (FE-SEM S-4800, manufactured by Hitachi). The observed image is saved as an image, and then the SEM image is graphed at the frequency of each image density using an image analyzing software. FIG. 3 is a view illustrating the frequency of each image density of the porous structure of the spinodal type porous structure. The peak portion indicated by the downward arrow of the image density of FIG. 3 represents the skeleton portion located at the front. The inflection point near the peak position is used as the threshold value, and then the bright portion (skeleton portion) and the dark portion (pore portion) are monochromatically binarized. The average value of all the images for the ratio of the black portion area to the entire area (total of the white portion area and the black portion area) is determined to be used as the porosity.

The pore diameter of the porous glass layer 2 is suitably 1 nm or more and 100 nm or lower, more suitably 5 nm or more and 50 nm or lower, and still more suitably 5 nm or more and 20 nm or lower. When the pore diameter is smaller than 1 nm, the characteristics of the structure of the porous body cannot be sufficiently utilized. When the pore diameter is larger than 100 nm, the surface strength tends to decrease. Thus, the pore diameters are not suitable. When the pore diameter is 20 nm or lower, the scattering of light is noticeably suppressed, and thus the pore diameter is suitable. The pore diameter is suitably smaller than the thickness of the porous glass layer 2.

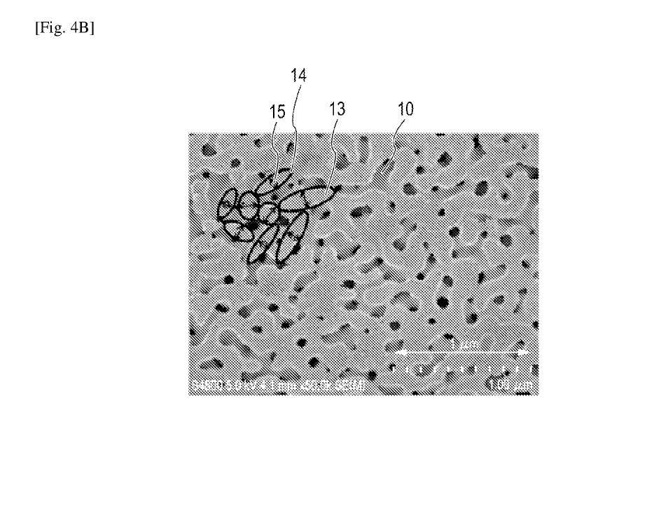

The pore diameter in the invention is defined as the average value of the minor axis in each of a plurality of ellipses by which the pores in a region of 5 micrometer*5 micrometer among arbitrary cross sections of the porous body are approximated. Specifically, as illustrated in FIG. 4A, for example, the value is obtained by approximating pores 10 by a plurality of ellipses 11 with reference to the electron micrograph of the porous body surface, and then calculating the average value of a minor axis 12 in each ellipse. At least 30 or more points are measured, and the average value thereof is determined.

The skeleton diameter of the porous glass layer 2 is suitably 1 nm or more and 100 nm or lower, more suitably 5 nm or more and 50 nm or lower, and still more suitably 5 nm or more and 20 nm or lower. When the skeleton diameter is larger than 100 nm, the scattering of light is noticeable, so that the transmittance sharply decreases. When the skeleton diameter is smaller than 1 nm, the strength of the porous glass layer 2 tends to become small. When the skeleton diameter is 20 nm or lower, the scattering of light is suppressed, and thus the skeleton diameter is suitable.

The skeleton diameter in the invention is defined as the average value of the minor axis in each of a plurality of ellipses by which the skeletons in a region of 5 micrometer* 5 micrometer among arbitrary cross sections of the porous body are approximated. Specifically, as illustrated in FIG. 4B, for example, the value is obtained by approximating skeletons 13 by a plurality of ellipses 14 with reference to the electron micrograph of the porous body surface, and then calculating the average value of a minor axis 15 in each ellipse. At least 30 or more points are measured, and the average value is calculated.

Attention is paid to the fact that since the scattering of light is complexly affected by the film thickness and the like of the optical member, the scattering of light is not uniquely determined only by the pore diameter and the skeleton diameter.

The pore diameter and the skeleton diameter of the porous glass layer 2 can be controlled by the materials serving as the raw materials, the heat treatment conditions in the spinodal type phase separation, and the like.

The porous glass layer 2 may have a configuration such that one or two or more porous glass layers may be laminated on the porous glass layer 2. As the entire porous glass layer 2, a configuration such that the porosity becomes higher from the base member 1 side to the surface of the porous glass layer is suitable because the effects of low reflectance are obtained.

In the optical member of the invention, a non-porous film whose refractive index is lower than that of the porous glass layer 2 may be provided on the surface of the porous glass layer 2.

As the base member 1, a base member containing an arbitrary material can be used according to the purpose. As the material of the base member 1, quartz glass and crystal are suitable, for example, from the viewpoint of transparency, heat resistance, and strength. The base member 1 may have a configuration such that layers containing different materials are laminated.

The base member 1 is suitably transparent. The transmittance of the base member 1 is suitably 50% or more and more suitably 60% or more in a visible light region (wavelength region of 450 nm or more and 750 nm or lower). When the transmittance is lower than 50%, a problem sometimes arises when used as an optical member.

Mentioned as the optical member of the invention are specifically optical members, such as various displays of a television, a computer, and the like, a polarizer for use in a liquid crystal display, a finder lens for camera, a prism, a fly eye lens, and a toric lens, various lenses, such as an imaging optical system employing the same, an observation optical system, such as binoculars, a projection optical system for use in a liquid crystal projector and the like, and a scanning optical system for use in a laser beam printer, and the like.

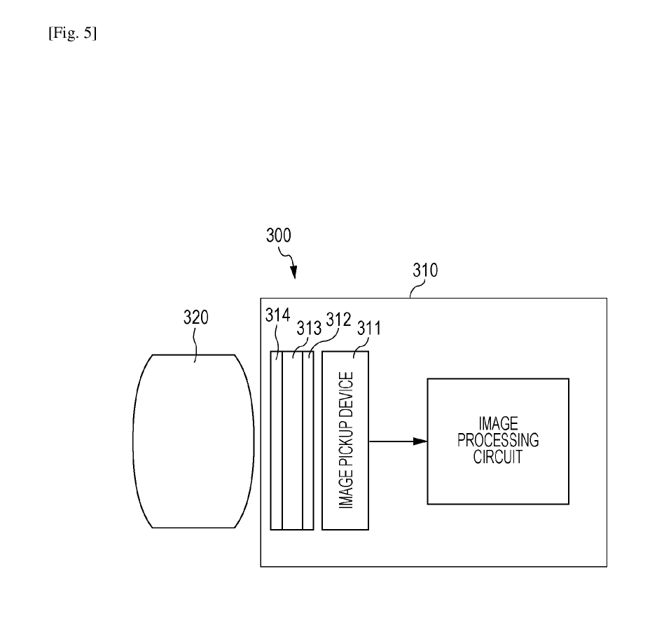

The optical member of the invention may be mounted also on an image pickup apparatus, such as a digital camera and a digital video camera. FIG. 5 is a cross-sectional schematic view illustrating a camera (image pickup apparatus) employing the optical member of the invention, specifically an image pickup apparatus for forming an image of a target image from a lens on an image pickup device through an optical filter. An image pickup apparatus 300 has a body 310 and a removable lens 320. An image pickup device, such as a digital single-lens reflex camera, can obtain various imaging screens of various field angles by exchanging an imaging lens for use in imaging to a lens having a different focal length. The body 310 has an image pickup device 311, an infrared cut filter 312, a low pass filter 313, and an optical member 314 of the invention. The optical member 314 has a base member 1 and a porous glass layer 2 as illustrated in FIG. 1.

The optical member 314 and the low pass filter 313 may be integrally formed or may be separated elements. A configuration such that the optical member 314 serves also as a low pass filter may be acceptable. More specifically, the base member 1 of the optical member 314 may be a low pass filter.

The image pickup device 311 is housed in a package (not illustrated). The package houses the image pickup device 311 in a sealing state with a cover glass (not illustrated). The space between the optical filter, such as the low pass filter 313 and the infrared cut filter 312, and the cover glass is sealed with a sealing member, such as double-stick tape. An example in which both the low pass filter 313 and the infrared cut filter 312 are provided is described as an optical filter but an optical filter having either one may be acceptable.

Since the surface of the optical member 314 of the invention has a porous structure, the surface has excellent dustproof performance, such as suppression of adhesion of dust. Thus, the optical member 314 is disposed in such a manner as to be located at the side opposite to the image pickup device 311 of the optical filter. The optical member 314 is disposed in such a manner that the porous glass layer 2 is further from the image pickup device 311 relative to the base member 1. In other words, it is suitable that the optical member 314 is disposed in such a manner that the base member 1 and the porous glass layer 2 are located in the stated order from the image pickup device 311 side. The optical member 314 and the image pickup device 311 are mutually disposed in such a manner that an image which transmits the optical member 314 can be captured by the image pickup device 311.

In the image pickup apparatus 300 of the invention, a foreign substance removal apparatus (not illustrated) for removing a foreign substance by applying vibration or the like may be provided. The foreign substance removal apparatus is configured in such a manner as to have a vibration member, a piezoelectric element, and the like.

The foreign substance removal apparatus may be disposed at any position insofar as the foreign substance removal apparatus is located between the image pickup device 311 and the optical member 314. For example, the foreign substance removal apparatus may be provided in such a manner that the vibration member is in contact with the optical member 314, the vibration member is in contact with the low pass filter 313, or the vibration member is in contact with the infrared cut filter 312. When the foreign substance removal apparatus is provided in such a manner that the vibration member is in contact with the optical member 314, foreign substances, such as dust and dirt, are hard to adhere to the optical member 314. Thus, the foreign substances can be more efficiently removed therefrom.

The vibration member of the foreign substance removal apparatus may be integrally formed with the optical member 314 or the optical filter, such as the low pass filter 313 or the infrared cut filter 312. The vibration member may be constituted by the optical member 314 and may have functions of the low pass filter 313, the infrared cut filter 312, and the like.

### Method for Manufacturing Optical Member

A method for manufacturing an optical member of the invention includes forming a glass powder layer containing a plurality of glass powders on a base member having a texture structure, fusing the glass powders of the glass powder layer to form a base glass layer, and then phase separating and etching the base glass layer to form a porous glass layer on the base member. In the invention, a case where, in order to obtain the base member having the textured structure, the textured structure is formed on the base member is described. However, the base member having the textured structure may be prepared by obtaining a commercially-available one, for example.

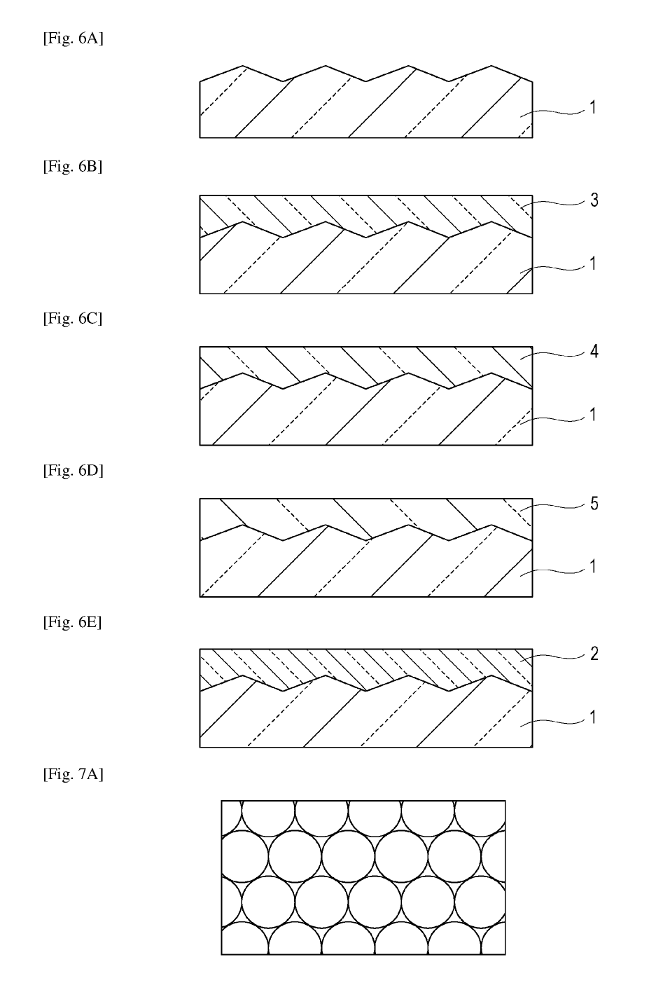

Next, each process of the method for manufacturing the optical member of the invention is described in detail with reference to FIG. 6A to FIG. 6E.

### Process for Forming Textured Structure on Base Member

First, as illustrated in FIG. 6A, a textured structure is formed on a base member 1.

As the base member 1, base members of arbitrary materials can be used according to the purpose. Mentioned as the materials of the base member 1 are quartz, crystal, and the like. The base member 1 may be a material of a low pass filter or a lens. The base member 1 is suitably one which contains silicon oxide and does not have phase separability. As the form of the base member 1, a base member of any form can be used insofar as a porous glass layer 2 can be formed thereon and the base member 1 may have curvature in the form.

Mentioned as a method for forming the textured structure on the base member 1 are mechanical polishing methods, such as blast polishing and barrel polishing, and wet etching methods using a corrosive liquid or the like. In addition thereto, mentioned as the method for forming the textured structure are dry etching methods, such as reactive gas etching, reactive ion etching, reactive ion beam etching, ion beam etching, and reactive laser beam etching, and the like. Any manufacturing method can be used singly or in combination insofar as the structure of the invention can be achieved.

According to the wet etching method, corrosive liquid, such as Frostec QEC-FG3 (manufactured by Frostec), is applied to the entire surface where the textured structure is to be formed of the base member 1, and, after a predetermined time passes, the base member 1 is sufficiently washed with water, whereby the textured structure is formed. The time for which the surface of the base member 1 is exposed to the corrosive liquid is required to be adjusted in terms of the reactivity, the concentration, and the like of the corrosive liquid.

As the mechanical polishing method, a method using resinoid is mentioned which includes rotating the resinoid while applying a weight to grind the surface of the base member 1, for example. The weight, the number of rotations, and the treatment time may be set as appropriate. The treatment is suitably performed for 5 minutes or more and 30 minutes or lower while applying a weight of 0.3 kg or more and 2.0 kg or lower and rotation of 30 rpm or more and 80 rpm or lower.

In addition thereto, mentioned as the method for forming the textured is a method which includes attaching a structure forming a convex portion onto the base member 1 by a vapor deposition method or a coating method.

As the structure forming the convex portion, fine particles disposed on the base member 1 are mentioned. More specifically, as illustrated in FIG. 15, as a process for forming the textured structure on the base member 1, a process for disposing fine particles on the base member 1 is mentioned. The fine particles are not particularly limited and, for example, colloidal silica, magnesium fluoride, zirconia, antimony oxide, tin oxide, and indium oxide are mentioned. Among the above, colloidal silica and magnesium fluoride are suitable from the viewpoint of transparency and light transmittance. As the form of the fine particles, fine particles of any form can be used insofar as the porous glass layer can be formed in the following process.

The softening temperature of the fine particles is suitably equal to or higher than the phase separation temperature of a spinodal type phase separation treatment in the following process and more suitably equal to or higher than a temperature obtained by adding 100 degrees (Celsius) to the phase separation temperature. When the softening temperature of the fine particles is lower than the heating temperature of the spinodal type phase separation treatment, the fine particles do not leave the form after the phase separation treatment, so that the convex portion may not be formed. Thus, the softening temperature is not suitable. The phase separation temperature of the spinodal type phase separation treatment refers to the maximum temperature among temperatures at which a glass layer derived from the spinodal type phase separation is formed.

The particle diameter of the fine particles may be in the range where the convex portion having a height of 100 nm or more is formed, and, specifically, may be 100 nm or more and 300 nm or lower. When the particle diameter is smaller than 100 nm, the ripple suppressing effect becomes low. When the particle diameter of the fine particles is larger than 300 nm, the level of the scattering of light becomes high, so that an optical member becomes cloud. A plurality kinds of fine particles having different particle diameters may be mixed to form the convex portion insofar as the particle diameters of the plurality kinds of fine particles are in the particle diameter range.

The interval between the fine particles is not particularly limited and is 100 nm or more and 500 nm or lower. When the interval of the fine particles is smaller than 100 nm, the number of portions where a glass powder layer in the following process does not enter between the fine particles increases, so that cavities are formed between the fine particles, which results in the fact that a desired refractive-index gradient is not obtained, and further the cavities causes scattering. On the other hand, when the interval becomes larger than 500 nm, the number of flat portions increases, so that a desired refractive-index gradient is not obtained.

As a method for disposing the fine particles on the base member 1, methods which allow the distribution and formation of the fine particles, such as a spin coating method, a dip coating method, a printing method, a vacuum deposition method, and a sputtering method, are mentioned. In the process for disposing the fine particles on the base member 1, the fine particles may be formed on the base member 1 not only with a solvent component but with other components in order to distribute the fine particles without aggregating. The other components to be distributed with the fine particles on the base members 1 are not particularly limited insofar as the component has an effect of suppressing the ripple. For example, fine particles (supplementary fine particles) with smaller particle diameter and high molecular weight compounds, such as polyvinyl alcohol, polyvinyl pyrrolidone, and polystyrene, are suitable.

As described above, the height of the textured structure is 100 nm or more and more suitably 250 nm or more for achieving the ripple suppressing effect. The upper limit is equal to or lower than the thickness of the porous glass layer 2. The height of the textured structure is suitably 1000 nm or lower in order to facilitate the manufacturing of the textured structure. More specifically, the height of the textured structure is more suitably 250 nm or more and 1000 nm or lower. The width of the textured structure is not particularly limited insofar as the ripple suppressing effect is demonstrated and is suitably 100 nm or more and 2000 nm or lower as described above.

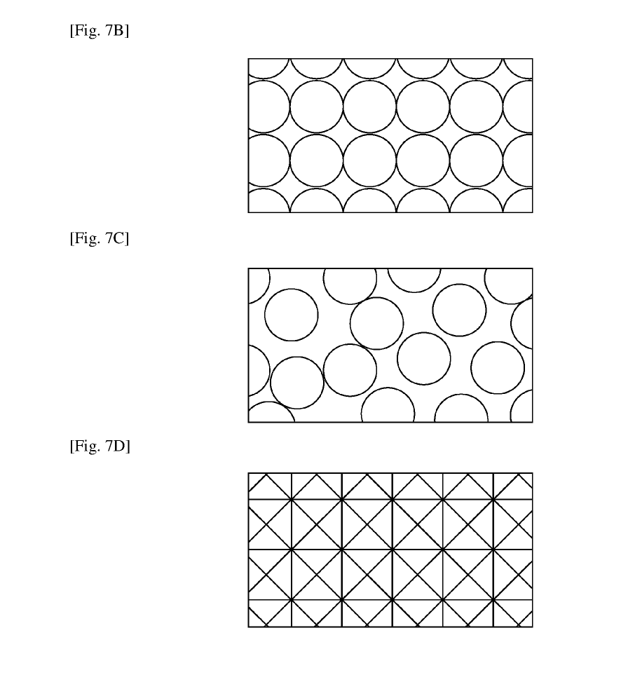

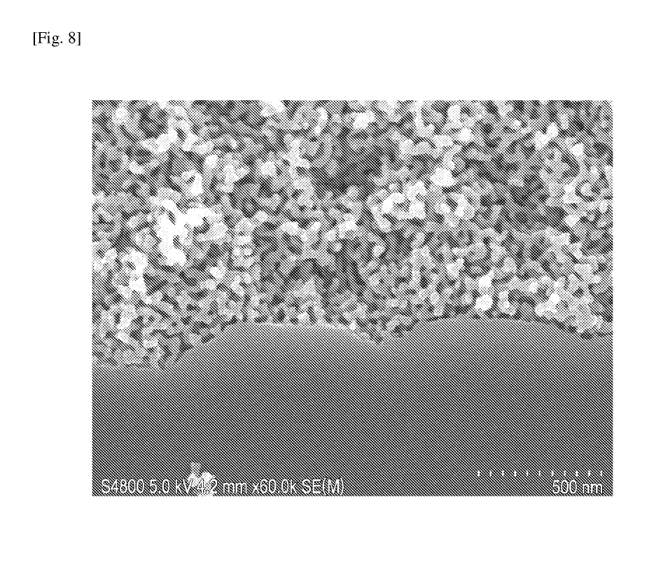

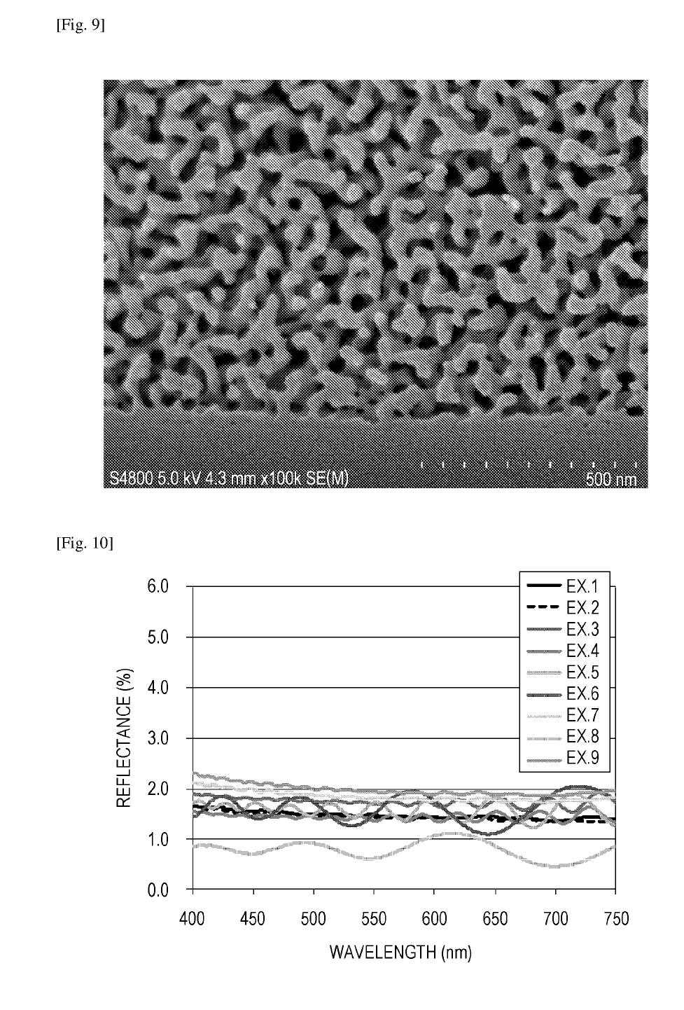

FIG. 7A to FIG. 7D illustrate plan schematic views of an example of the textured structure formed on the base member 1. As illustrated in FIG. 7A, the convex portion of the textured structure may be a conical shape. The textured structure may be a structure such that the convex portions are arranged on the surface of the base member 1 in the closest packing arrangement. As illustrated in FIG. 7B, the textured structure may be a structure such that the conical convex portions are arranged in the shape of a lattice. In addition thereto, as illustrated in FIG. 7C, the textured structure may not be a periodical structure but a randomly arranged structure. As illustrated in FIG. 7D, the convex portion of the textured structure may have a quardrangular pyramid shape and a structure such that the convex portions are arranged in the shape of a lattice. In addition thereto, the convex portion of the textured structure may have a triangular pyramid shape, a truncated cone shape, a pyramid cone shape, a triangular pyramid cone shape, a columnar shape, a quadratic prism shape, and a triangular prism shape.

Herein, when the height of the textured structure is the same as the thickness of the porous glass layer 2 in the case where the convex portion of the textured structure has a columnar shape, a quadratic prism shape, or a triangular prism shape, the porosity gradient structure is not formed, and therefore the reduction in ripple is not achieved. Therefore, in such a configuration, it is suitable to reduce the thickness of the porous glass layer 2 to half or lower in order to give a substantial porosity gradient in the porous glass layer 2.

More specifically, in the invention, the form of the textured structure and the height of the textured structure are adjusted in such a manner as to have a configuration such that a substantial porosity change near the interface of the porous glass layer 2 and the base member 1 is achieved.

### Process for Forming Glass Powder Layer

Next, as illustrated in FIG. 6B, a glass powder layer 3 containing glass powder is formed on the surface on which the textured structure is formed of the base member 1.

In the invention, it is indispensable to form the porous glass layer 2 having a porous structure derived from the spinodal type phase separation on the base member 1. To that end, precise composition control of glass is required. A method is suitable which includes determining the glass composition once, producing glass powder having phase separability, applying the glass powder onto the base member 1, and then melting the same to form a film.

The phase separability refers to a characteristic such that phase separation occurs by heat treatment. Mentioned as the phase separable glass are, for example, silicon oxide glass I (silicon oxide-boron oxide-alkali metal oxide), silicon oxide glass II (silicon oxide-boron oxide-alkali metal oxide-(alkaline earth metal oxide, zinc oxide, aluminum oxide, zirconium oxide)), titanium oxide glass (silicon oxide-boron oxide-calcium oxide-magnesium oxide-aluminum oxide-titanium oxide) and the like. Among the above, the borosilicate glass of silicon oxide-boron oxide-alkali metal oxide is suitable. In the borosilicate glass, glass having a composition such that the proportion of the silicon oxide is 55.0% by weight or more and 95.0% by weight or lower and particularly 60.0% by weight or more and 85.0% by weight or lower is suitable. When the proportion of the silicon oxide is in the range mentioned above, there is a tendency such that a phase-separated glass with high skeleton strength is obtained, and such a glass is useful when strength is required. The molar ratio of the boron to the alkaline component is suitably 0.25 or more and 0.40 or lower. When the ratio is outside the range, the film is sometimes broken due to expansion and contraction during etching.

As a method for manufacturing a base glass serving as a phase separable glass powder, the base glass can be manufactured using known methods except preparing raw materials in such a manner as to achieve the phase separable glass composition described above. For example, the base glass can be manufactured by heating and melting raw materials containing the supply source of each component, and molding the resultant substance into a desired shape as required. The heating temperature for heating and melting may be determined as appropriate in accordance with the raw material composition and the like. In general, the heating and melting may be performed in the range of 1350 degrees (Celsius) or higher and 1500 degrees (Celsius) or lower.

Thereafter, the base glass is pulverized to obtain glass powder. A pulverization method is not required to be particularly limited, and known pulverization methods can be used. Mentioned as an example of the pulverization method is a crushing method in a liquid phase typified by a bead mill or a crushing method in a vapor phase typified by a jet mill.

As a method for forming the glass powder layer 3, a printing method, a spin coating method, a dip coating method, and the like are mentioned. Hereinafter, a description is given with reference to a method using a general screen printing method as an example. Since a glass powder is formed into a paste, and is printed using a screen printer in the screen printing method, the preparation of the paste is indispensable. The paste contains thermoplastic resin, a plasticizer, a solvent, and the like with the glass powder.

It is desirable that the proportion of the glass powder contained in the paste is in the range of 30.0% by weight or more and 90.0% by weight or lower and suitably in the range of 35.0% by weight or more and 70.0% by weight or lower.

The thermoplastic resin contained in the paste is a component which increases the film strength after drying and imparts flexibility. Usable as the thermoplastic resin are polybutyl metacrylate, polyvinyl butyral, polymethyl metacrylate, polyethyl metcrylate, ethyl cellulose, and the like. The thermoplastic resin can be used alone or as a mixture of two or more kinds thereof. The content of the thermoplastic resin contained in the paste is suitably 0.1% by weight or more and 30.0% by weight or lower. When the content is smaller than 0.1% by weight, the film strength after drying tends to become weak. When the content is larger than 30.0% by weight, the residual resin component is likely to remain in the film after fusing, and thus the content is not suitable.

Mentioned as the plasticizer contained in the paste are butyl benzyl phthalate, dioctyl phthalate, diisooctyl phthalate, dicapryl phthalate, dibutyl phthalate, and the like. These plasticizers can be used alone or as a mixture of two or more kinds thereof. The content of the plasticizer contained in the paste is suitably 10.0% by weight or lower. By adding the plasticizer, the drying rate is controlled and also flexibility can be given to a dry film.

Mentioned as the solvent contained in the paste are terpineol, diethylene glycol monobutyl ether acetate, 2,2,4-trimethyl-1,3-pentadiol monoisobutyrate, and the like. The solvents can be used alone or as a mixture of two or more kinds thereof. The content of the solvent contained in the paste is suitably 10.0% by weight or more and 90.0% by weight or lower. When the content is smaller than 10.0% by weight, there is a tendency such that it becomes difficult to obtain a uniform film. When the content exceeds 90.0% by weight, there is a tendency such that it becomes difficult to obtain a uniform film.

The paste may be produced by kneading the above-described materials at a given ratio.

Such a paste is applied onto the base member 1 by a screen printing method, and then the solvent component of the paste is dried and removed, whereby the glass powder layer 3 containing the glass powder can be formed. In order to achieve a target thickness, the paste may be applied in a laminated manner with an arbitrary number of times and dried.

### Process for Fusing Glass Powder

Subsequently, as illustrated in FIG. 6C, by fusing the glass powders of the glass powder layer 3 by heating, a phase separable base glass layer 4 is formed on the base member 1.

When the temperature during the fusing is higher, the viscosity of the glass decreases, so that a flat film is likely to be formed, and the film hardly causes scattering on the surface. However, when the temperature during the fusing is equal to or higher than the crystallization temperature of the glass powder, the phase separable base glass layer 4 is crystallized. The crystals cause scattering, which causes a reduction in transmittance. Therefore, in the invention, by performing the fusing process by heating at a temperature equal to or higher than the glass transition temperature and equal to or lower than the crystallization temperature, the base glass layer 4 can be formed by fusing the glass powder without crystallization. The heating is suitably performed at a temperature of 500 degrees (Celsius) or higher and 800 degrees (Celsius) or lower, which varies depending on the difference in the glass composition and the temperature increase rate. The heating is suitably held for 5 minutes or more and 100 hours or lower.

In order to remove the formed crystals, a method may be taken which includes fusing the glass powder at a temperature of 800 degrees (Celsius) or higher and 1300 degrees (Celsius) or lower, for example. In this case, even when the crystals are formed during temperature elevation, the crystals themselves are melted since the fusing temperature is high. Therefore, the crystals are difficult to remain on the base glass layer 4. As the heating time, the heating is suitably held for 1 minute or more and 60 minutes or lower.

From the viewpoint of obtaining an optical member with a high transmittance, the oxygen concentration during the fusing is suitably higher than 20% and more suitably 50% or higher.

As the heating method in the fusing, an electric furnace, an oven, resistance heating, infrared lamp heating, and the like are mentioned. Particularly the infrared lamp heating is suitable. It is suitable to heat from the base member 1 by providing a setter, such as SiC and Si, under the base member 1.

### Process for Forming Phase-Separated Glass Layer

Next, as illustrated in FIG. 6D, the phase separable base glass layer 4 formed on the base member 1 is heated to thereby form a phase-separated glass layer 5. The phase-separated glass layer 5 as used herein refers to a glass layer in which the phases are separated into a silicon-oxide-rich phase and a non-silicon-oxide-rich phase.

The heat treatment for the phase separation is performed by holding the same at a temperature of 500 degrees (Celsius) or higher and 700 degrees (Celsius) or lower for 1 hour or more and 100 hours or lower. The temperature and the time can be set as appropriate according to the pore diameter and the like of the porous glass layer 2 to be obtained. The heat treatment temperature is not required to be a fixed temperature and may be continuously changed in a stepwise manner.

As the heating method, the methods mentioned in the process for fusing the glass powder can be employed.

### Process for Forming Porous Glass Layer

Next, as illustrated in FIG. 6E, the phase-separated glass layer 5 formed on the base member 1 is etched, and then the porous glass layer 2 having continuous pores is formed on the base member 1. By the etching treatment, the non-silicon-oxide-rich phase can be removed while leaving the silicon-oxide-rich phase of the phase-separated glass layer 5 and the portion where the silicon-oxide-rich phase remains becomes the skeleton of the porous glass layer 2 and the portion from which the non-silicon-oxide-rich phase is removed becomes a pore of the porous glass layer 2.

As the etching treatment for removing the non-silicon-oxide-rich phase, treatment is generally used which includes eluting the non-silicon-oxide-rich phase which is soluble by bringing the same into contact with an aqueous solution. As a method for bringing the aqueous solution into contact with the glass, a method for immersing the glass in the aqueous solution is generally used. The method is not limited at all insofar as the glass and the aqueous solution are brought into contact with each other, e.g., applying the aqueous solution to the glass. As the aqueous solution required for the etching treatment, existing solutions which can elute the non-silicon-oxide-rich phase, such as water, an acid solution, and an alkaline solution, can be used. A plurality kinds of processes for bringing glass into contact with the solutions may be selected according to the intended use.

In general etching treatment of the phase-separated glass, acid treatment is suitably used from the viewpoint of reducing the load to a non-soluble phase (silicon-oxide-rich phase) portion and the viewpoint of the selective etching degree. By bringing the same into contact with acid solution, the non-silicon-oxide-rich phase which is an acid soluble component is eluted and removed but the erosion degree of the silicon-oxide-rich phase is relatively low and high selective etching properties can be achieved.

As the acid solution, inorganic acid, such as hydrochloric acid and nitric acid, is suitable, for example. As the acid solution, it is generally suitable to use an aqueous solution in which water is used as the solvent. The concentration of the acid solution may be set as appropriate in the range of 0.1 mol/L or more and 2.0 mol/L or lower. In the acid treatment process, the temperature of the acid solution may be set in the range of room temperature to 100 degrees (Celsius) and the treatment time may be set to 1 hour or more and 500 hours or lower.

Depending on the glass composition, a silicon oxide layer of about hundreds of nm which blocks the etching is formed on the glass surface after the phase separation treatment in some cases. The surface layer can also be removed by polishing, alkaline treatment, or the like.

Depending on the glass composition, a gel-like silicon oxide is accumulated on the skeleton in some cases. As required, a method for etching in many stages using acid etching liquid having different acidity or water can be used. As the etching temperature, the etching can also be performed at 15 degrees (Celsius) or higher and 95 degrees (Celsius) or lower. As required, the etching can also be performed by applying ultrasonic waves during the etching treatment.

In general, it is suitable that the treatment is performed with acid solution, an alkaline solution, or the like, and then water treatment is performed. By performing the water treatment, an adherent of the residual component to the porous glass skeleton can be suppressed, so that there is a tendency such that the porous glass layer 2 with higher porosity can be obtained.

The temperature in the water treatment process is generally suitably in the range of 15 degrees (Celsius) or higher and 100 degrees (Celsius) or lower. The time of the water treatment process can be suitably set according to the composition, the size, and the like of the target glass and may be generally set to 1 hour or more and 50 hours or lower.

### EXAMPLES

Examples are described below but the invention is not limited by the Examples.

### Production Example of Glass Powder

A mixed powder containing quartz powder, boron oxide, sodium oxide, and alumina was melted at 1500 degrees (Celsius) for 24 hours using a platinum crucible in such a manner as to have a charge composition of 64% by weight SiO₂, 27% by weight B₂O₃, 6% by weight Na₂O, and 3% by weight Al₂O₃. Thereafter, the temperature of the glass was lowered to 1300 degrees (Celsius), and then poured into a graphite mold. The mold was allowed to cool in the air for about 20 minutes, held in a 500 degrees (Celsius) slow cooling furnace for 5 hours, and then allowed to cool over 24 hours, thereby obtaining a glass body. A block of the obtained borosilicate glass was ground using a jet mill until the average particle diameter reached 4.5 micrometer, whereby glass powder was obtained.

### Production Example of Glass Paste

Glass powder obtained above 60.0 parts by mass

alpha-terpineol 44.0 parts by mass

Ethyl cellulose (Registered trade mark: ETHOCEL Std 200 (manufactured by Dow Chemical Co.)) 2.0 parts by mass

The raw materials were stirred and mixed, thereby obtaining a glass paste. The viscosity of the glass paste was 31300 mPa*s.

### Example 1

As a base member, a 1.1 mm thick quartz base member (manufactured by IIYAMA PRECISION GLASS Co., Ltd., Softening point of 1700 degrees (Celsius), Young's modulus of 72 GPa) which was cut into a size of 50 mm*50 mm and was mirror polished was used.

First, Frostec QEC-FG3 (manufactured by Frostec) which is an etching sol solution for glass (corrosive agent) was applied to the surface of the base member. The base member was allowed to stand still in the state where the sol solution was brought into contact with the surface at 25 degrees (Celsius) for 30 minutes. Thereafter, the sol solution was removed, and then the base member was washed with water. Thus, a textured structure was formed on the surface of the base member.

Subsequently, the glass paste was applied by screen printing onto the surface on which the textured structure was formed of the base member. As the printing machine, MT-320TV manufactured by MICRO-TEC Co., Ltd. was used. As the plate, a solid image of 30 mm*30 mm of #500 was used.

Subsequently, the resultant substance was allowed to stand still in a 100 degrees (Celsius) drying furnace for 10 minutes to dry the solvent content, thereby obtaining a glass powder layer. The thickness of the formed glass powder layer was 10.00 micrometer as measured by SEM.

As a resin removing process, the glass powder layer was heated to 350 degrees (Celsius) at 5 degrees (Celsius)/min, and then heat-treated for 3 hours. Next, as a fusing process, the temperature was increased to 700 degrees (Celsius) at a temperature increase rate of 5 degrees (Celsius)/min, and then heat-treated for 1 hour, to thereby obtain a base glass layer.

Thereafter, a phase separation treatment process, the temperature of the base glass layer was lowered to 600 degrees (Celsius) at 10 degrees (Celsius)/min, and then heat-treated at 600 degrees (Celsius) for 50 hours. Then, the surface of the obtained film was ground to thereby obtain a phase-separated glass layer.

The phase-separated glass layer was immersed in 1.0 mol/L of an aqueous nitric acid solution heated to 80 degrees (Celsius), and then allowed to stand still at 80 degrees (Celsius) for 24 hours. Subsequently, the resultant substance was immersed in distilled water heated to 80 degrees (Celsius), and then allowed to stand still for 24 hours. The glass body was taken out from the solution, and then dried at room temperature for 12 hours, thereby obtaining a sample 1.

FIG. 8 is a portion of a SEM image of the cross section of the sample 1. When the SEM image of the cross section was analyzed, the porosity of the porous glass layer was 49%, the pore diameter was 45 nm, and the skeleton diameter was 30 nm.

The textured structure was formed. The height of the textured structure was 300 nm and the interval of the textured structure was 900 nm. The thickness of the porous glass layer was 4.0 micrometer.

### Example 2

In this example, a sample 2 was obtained in the same manner as in Example 1, except that a method for forming a textured structure on the surface of a base member is different from that in Example 1. In this example, the textured structure on the base member was formed by polishing. For the polishing, resinoid was used and the treatment was performed for 10 minutes while applying a weight of 1.3 kg thereto and rotating the same at 60 rpm.

When the cross section of the sample 2 was observed under SEM, it was able to be confirmed that the textured structure was formed. The height of the textured structure was 850 nm, the interval of the textured structure was 950 nm, and the thickness of the porous glass layer was 5.0 micrometer.

The porosity of the porous glass layer was 49%, the pore diameter was 45 nm, and the skeleton diameter was 30 nm.

### Example 3

This example is different from Example 1 in that the time for which the sol solution was brought into contact with the base member surface was 60 minutes. A sample 3 was obtained in the same manner as in Example 1 except the time.

When the cross section of the sample 3 was observed under SEM, it was able to be confirmed that the textured structure was formed. The height of the textured structure was 500 nm, the interval of the textured structure was 700 nm, and the thickness of the porous glass layer was 3.0 micrometer.

The porosity of the porous glass layer was 49%, the pore diameter was 44 nm, and the skeleton diameter was 31 nm.

### Example 4

This example is different from Example 1 in that the time for which the sol solution was brought into contact with the base member surface was 10 minutes. A sample 4 was obtained in the same manner as in Example 1 except the time.

When the cross section of the sample 4 was observed under SEM, it was able to be confirmed that the textured structure was formed. The height of the textured structure was 250 nm, the interval of the textured structure was 250 nm, and the thickness of the porous glass layer was 3.5 micrometer.

The porosity of the porous glass layer was 48%, the pore diameter was 44 nm, and the skeleton diameter was 30 nm.

### Example 5

This example is different from Example 1 in that the time for which the sol solution was brought into contact with the base member surface was 5 minutes. A sample 5 was obtained in the same manner as in Example 1 except the time.

When the cross section of the sample 5 was observed under SEM, it was able to be confirmed that the textured structure was formed. The height of the textured structure was 100 nm, the interval of the textured structure was 150 nm, and the thickness of the porous glass layer was 3.0 micrometer.

The porosity of the porous glass layer was 50%, the pore diameter was 45 nm, and the skeleton diameter was 30 nm.

### Example 6

This example is different from Example 2 in that the treatment was performed for 15 minutes while applying a weight of 1.3 kg and rotating at 60 rpm. A sample 6 was obtained in the same manner as in Example 2 except the conditions.

When the cross section of the sample 6 was observed under SEM, it was able to be confirmed that the textured structure was formed. The height of the textured structure was 150 nm, the interval of the textured structure was 2000 nm, and the thickness of the porous glass layer was 5.0 micrometer.

The porosity of the porous glass layer was 51%, the pore diameter was 46 nm, and the skeleton diameter was 30 nm.

### Example 7

This example is different from Example 2 in that the treatment was performed for 15 minutes while applying a weight of 0.7 kg and rotating at 60 rpm. A sample 7 was obtained in the same manner as in Example 2 except the conditions.

When the cross section of the sample 7 was observed under SEM, it was able to be confirmed that the textured structure was formed. The height of the textured structure was 950 nm, the interval of the textured structure was 1500 nm, and the thickness of the porous glass layer was 5.0 micrometer.

The porosity of the porous glass layer was 49%, the pore diameter was 44 nm, and the skeleton diameter was 28 nm.

### Example 8

This example is different from Example 2 in that the treatment was performed for 15 minutes while applying a weight of 0.8 kg and rotating at 40 rpm. A sample 8 was obtained in the same manner as in Example 2 except the conditions.

When the cross section of the sample 8 was observed under SEM, it was able to be confirmed that the textured structure was formed. The height of the textured structure was 800 nm, the interval of the textured structure was 2500 nm, and the thickness of the porous glass layer was 5.0 micrometer.

The porosity of the porous glass layer was 47%, the pore diameter was 43 nm, and the skeleton diameter was 28 nm.

### Example 9

This example is different from Example 1 in that the time for which the sol solution was brought into contact with the base member surface was 60 minutes and the temperature at which the resultant substance was allowed to stand was 80 degrees (Celsius). A sample 9 was obtained in the same manner as in Example 1 except the conditions. When the cross section of the sample 9 was observed under SEM, it was able to be confirmed that the textured structure was formed. The height of the textured structure was 2000 nm, the interval of the textured structure was 2200 nm, and the thickness of the porous glass layer was 3.0 micrometer.

The porosity of the porous glass layer was 48%, the pore diameter was 45 nm, and the skeleton diameter was 29 nm.

### Comparative Example 1

In this comparative example, a sample 10 was obtained in the same manner as in Example 1, except that the surface of the base member was not subjected to the surface treatment with a sol solution.

FIG. 9 is a SEM image of the cross section of the sample 10. As illustrated in FIG. 9, it was observed that the porous glass layer is formed but the textured structure was not formed on the base member. When the cross section of the sample 10 was observed under SEM, a uniform porous glass layer having a thickness of 2.0 micrometer was formed.

The porosity of the porous glass layer was 48%, the pore diameter was 46 nm, and the skeleton diameter was 30 nm.

### Comparative Example 2

This example is different from Example 1 in that the time for which the sol solution was brought into contact with the base member surface was 5 minutes and the temperature at which the resultant substance was allowed to stand was 0 degrees (Celsius). A sample 11 was obtained in the same manner as in Example 1 except the conditions.

When the cross section of the sample 11 was observed under SEM, it was able to be confirmed that the textured structure was formed. The height of the textured structure was 80 nm, the interval of the textured structure was 30 nm, and the thickness of the porous glass layer was 2.5 micrometer.

The porosity of the porous glass layer was 48%, the pore diameter was 46 nm, and the skeleton diameter was 31 nm.

### Comparative Example 3

This example is different from Example 2 in that the treatment was performed for 10 minutes while applying a weight of 0.3 kg and rotating at 40 rpm. A sample 12 was obtained in the same manner as in Example 2 except the conditions.

When the cross section of the sample 12 was observed under SEM, it was able to be confirmed that the textured structure was formed. The height of the textured structure was 800 nm, the interval of the textured structure was 2500 nm, and the thickness of the porous glass layer was 5.0 micrometer.

The porosity of the porous glass layer was 48%, the pore diameter was 45 nm, and the skeleton diameter was 31 nm.

### Method for Measuring Surface Reflectance

The surface reflectance of each optical member of Examples 1 to 9 and Comparative Examples 1 to 3 was measured in a range of a wavelength region of 400 nm to 750 nm at 1-nm intervals using a lens reflectance meter (USPM-RU, manufactured by Olympus, Inc.).

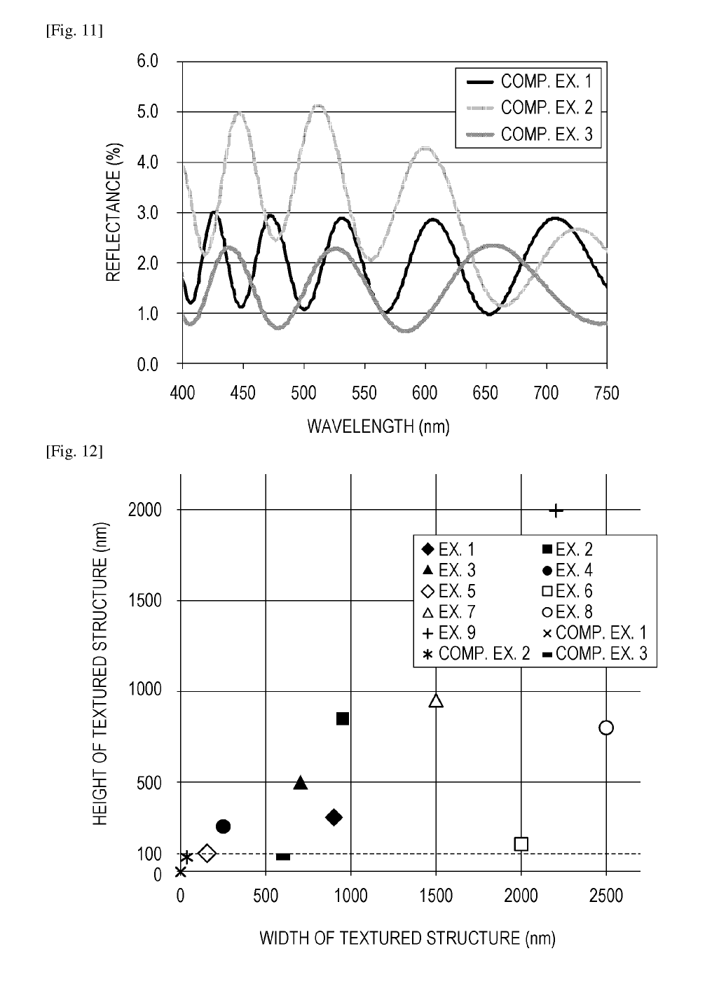

The results of the surface reflectance of Examples 1 to 9 are shown in FIG. 10 and the results of the surface reflectance of Comparative Examples 1 to 3 are shown in FIG. 11. The reflectance of the quartz glass used for the base member was about 3.3% over the range of the wavelength region of 400 nm to 750 nm.

In each sample of Comparative Examples 1 to 3, since a difference between the maximum value and the minimum value of the surface reflectance in the wavelength region mentioned above is larger than 1.0, which shows that the dependency of the reflectance on the wavelength is high. In contrast thereto, in each sample of Examples 1 to 9, since a difference between the maximum value and the minimum value of the surface reflectance in the wavelength region mentioned above is 1.0 or lower, which shows that the dependency of the reflectance on the wavelength is low.

In Comparative Example 1, since the textured structure is not formed on the interface of the base member and the porous glass layer, the reflection degree on the interface of the base member and the porous glass layer is high, so that it is considered that ripple occurs.

In Comparative Examples 2 and 3, although the configuration such that the textured structure was formed was achieved, the height of the textured structure is smaller than 100 nm, and therefore the substantial porosity in the thickness direction of the porous glass layer sharply changes near the interface of the base member and the porous glass layer, so that it is considered that ripple was not suppressed.

In Comparative Example 2, since the width of the textured structure is smaller than 100 nm, it is considered that the glass powder did not enter the concave portion of the textured structure. Therefore, it is considered that cavities were formed between the porous glass layer and the base member and the reflection degree on the interface of the cavities and the base member and the reflection degree on the interface of the porous glass layer and the cavities become high, so that the reflectance in the wavelength region mentioned above was higher than that of Comparative Example 1.

In Examples 1 to 9, since the height of the textured structure is 100 nm or more, the substantial porosity in the thickness direction of the porous glass layer gradually changes near the interface of the base member and the porous glass layer, so that it is considered that ripple was suppressed.

### Evaluation of Haze Value

The haze value of Examples 1 to 9 and Comparative Examples 1 to 3 was measured using a haze meter (NDH2000, manufactured by Nippon Denshoku, Inc.), and are shown together in Tables 1 and 2 below.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Haze | 16.01 | 16.44 | 14.79 | 15.32 | 14.97 | 19.85 | 19.47 | 22.74 | 32.05 |
| value | | | | | | | | | |
| (%) | | | | | | | | | |

TABLE 2

| | Comp. Ex. 1 | Comp. Ex. 2 | Comp. Ex. 3 |
|---|---|---|---|
| Haze value (%) | 13.42 | 14.97 | 18.88 |

In the samples of Examples 8 and 9, since the width of the textured structure exceeds 2000 nm (2 micrometer), the scattering level due to the textured structure is high.

FIG. 12 illustrates the plot of each sample of Examples and each sample of Comparative Examples in which the vertical axis represents the width of the textured structure and the horizontal axis represents the height of the textured structure. The dashed line of FIG. 12 represents that the height of the textured structure is 100 nm.

### Examples 10 to 16

For the base member, the same one as that of Example 1 was used

First, a solution containing colloidal silica was produced using isopropyl alcohol as a solvent, and then the solution was applied onto the base member by a spin coating method in a film forming process at 5000 rpm for 30 seconds to thereby distribute and arrange the colloidal silica on the base member. The particle diameter of the colloidal silica used in each Example in this case is shown in Table 3. In order to distribute the fine particles without aggregating the same, supplementary fine particles or polyvinyl pyrrolidone were/was added in Examples 10 to 12, 15, and 16. The added substance and the weight ratio of the added substance to the main fine particles are also shown in Table 3.

Subsequently, the glass powder layer was formed in the same manner as in Example 1. The thickness of the formed glass powder layer was 4.00 micrometer as measured by SEM. Thereafter, samples 10 to 16 having a porous glass layer were obtained in the same manner as in Example 1.

When the samples were observed under SEM, the porous glass layer was formed on the base member, and the textured structure having a height of 100 nm or more was formed on the interface of the base member and the porous glass layer in the samples 10 to 16. In the samples 10 to 16, with respect to the interval of the fine particles, the interval between the colloidal particles at 40 points were sampled from the SEM photograph of the vicinity of the interface, and then the minimum value and the maximum value were measured. The values are shown in Table 3.

TABLE 3

| | | | Additives | | |
|---|---|---|---|---|---|
| | Fine particles | | | | Value of |
| | | Interval | | | weight ratio |
| | Particle | between | | Particle | of additives |
| | diameter | particles | | diameter | to main fine |
| | (nm) | (nm) | Type | (nm) | particles |
| Ex. 10 | 100 | 150 | Colloidal | 20 | 0.5 |
| | | | silica | | |
| Ex. 11 | 120 | 250 | Colloidal | 40 | 0.5 |
| | | | silica | | |
| Ex. 12 | 200 | 300 | Colloidal | 30 | 2.0 |
| | | | silica | | |
| Ex. 13 | 100 | 400 | | | |
| Ex. 14 | 100 | 450 | | | |
| Ex. 15 | 100 | 150 | Polyvinyl | | 4.0 |
| | | | pyrrolidone | | |
| Ex. 16 | 120 | 200 | Polystyrene | 30 | 1.0 |

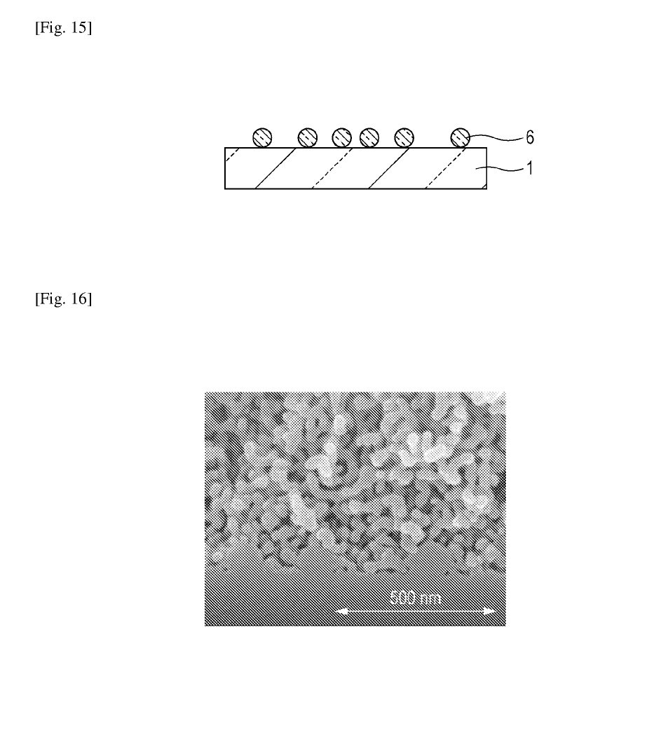

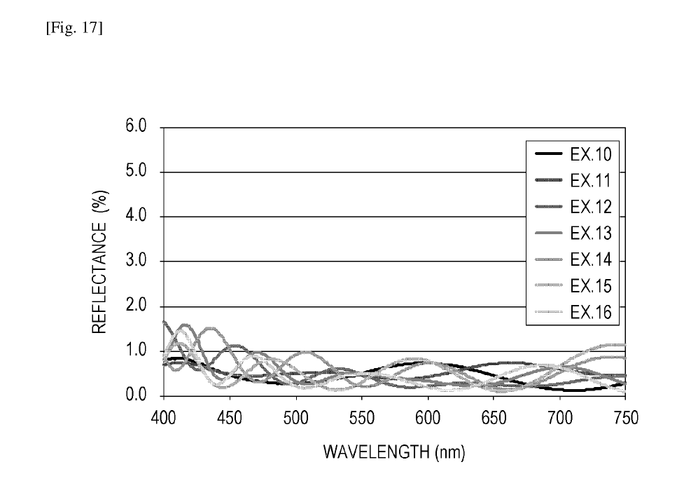

FIG. 16 is a portion of the SEM image of the cross section of the sample 10. When the SEM image of the cross section was analyzed, the porosity of the porous glass layer was 52%, the pore diameter was 41 nm, and the skeleton diameter was 36 nm.

The surface reflectance of each optical member of Examples 10 to 16 was measured in a range of a wavelength region of 400 nm to 750 nm at 1-nm intervals using a lens reflectance meter (USPM-RU, manufactured by Olympus, Inc.).

The reflectance of the quartz glass used for the base member was about 3.3% over the range of the wavelength region of 400 nm to 750 nm.

In each sample of Examples 10 to 16, since a difference between the maximum value and the minimum value of the surface reflectance in the wavelength region mentioned above is 1.0 or lower, which shows that the dependency of the reflectance on the wavelength is low.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-123566, filed May 30, 2012 and No. 2013-097078, filed May 2, 2013, which are hereby incorporated by reference herein in their entirety.

### REFERENCE SIGNS LIST

1 Base member
2 Porous glass layer
3 Glass powder Layer
4 Base glass layer
5 Phase-separated glass layer

1. An optical member, comprising:
a base member; and
a porous glass layer formed on the base member,
a textured structure formed on an interface contacting the porous glass layer of the base member, wherein a height of the textured structure is 100 nm or more and equal to or lower than a thickness of the porous glass layer.

2. The optical member according to claim 1, wherein the height of the textured structure is 250 nm or more and 1000 nm or lower.

3. The optical member according to claim 1, wherein a width of the textured structure is 100 nm or more and 2000 nm or lower.

4. The optical member according to claim 1, comprising a porous structure in which pores three-dimensionally communicate with each other.

5. The optical member according to claim 1, wherein the textured structure is formed with particles.

6. The optical member according to claim 5, wherein a particle diameter of the particles is 100 nm or more and 300 nm or lower.

7. An image pickup apparatus comprising:
the optical member according to claim 1; and an image pickup device which captures an image which transmits the optical member.

8. The image pickup apparatus according to claim 7, wherein, in the optical member, the base member and the porous glass layer are disposed in order from the image pickup device side.

9. A method for manufacturing an optical member having a base member and a porous glass layer formed on the base member, the method comprising;
preparing a base member having a textured structure; and
forming a porous glass layer on a surface of the textured structure of the base member,
wherein a height of the textured structure is 100 nm or more and equal to or lower than a thickness of the porous glass layer.

10. The method for manufacturing an optical member according to claim 9, wherein the height of the textured structure is 250 nm or more and 1000 nm or lower.

11. The method for manufacturing an optical member according to claim 9, wherein a width of the textured structure is 100 nm or more and 2000 nm or lower.

12. The method for manufacturing an optical member according to claim 9, wherein the preparing of the base member includes forming the textured structure on the base member.

13. The method for manufacturing an optical member according to claim 12, wherein the formation of the textured structure includes etching a surface of the base member by a wet etching method.

14. The method for manufacturing an optical member according to claim 12, wherein the formation of the textured structure includes polishing a surface of the base member to form the textured structure.

15. The method for manufacturing an optical member according to claim 12, wherein the formation of the textured structure includes arranging particles on the base member.

16. The method for manufacturing an optical member according to claim 15, wherein a particle diameter of the particles is 100 nm or more and 300 nm or lower.

17. The method for manufacturing an optical member according to claim 9, wherein the formation of the porous glass layer includes:
forming a glass powder layer containing a plurality of glass powders on the textured structure;
fusing the plurality of glass powders of the glass powder layer to form a phase-separable base glass layer;
phase separating the base glass layer to form a phase-separated glass layer; and
etching the phase-separated glass layer to form the porous glass layer.
